(19) United States
(12) Patent Application Publication
(10) Pub. No.: US 2023/0057737 A1
(43) Pub. Date: Feb. 23, 2023

(54) Ultrasound Coupling Shoe

(71) Applicant: DolphiTech AS, Gjøvik (GB)

(72) Inventors: Eskil Skoglund, Gjøvik (NO); Tore Magne Skar, Asker (NO); Fredrik Lingvall, Oslo (NO)

(21) Appl. No.: 17/793,185

(22) PCT Filed: Jan. 15, 2021
(86) PCT No.: PCT/EP2021/050863

§ 371 Date: Jul. 15, 2022

(30) Foreign Application Priority Data
Jan. 17, 2020 (GB) 2000723.3

(51) Int. Cl. G01N 29/28; G01N 29/06; G01N 29/04; G01N 29/22; G01N 29/24

(52) U.S. Cl. CPC G01N 29/28; G01N 29/069; G01N 29/043; G01N 29/041; G01N 29/225; G01N 29/24

(57) ABSTRACT

A coupling shoe for attachment to a transducer module to couple ultrasound transmitted by the transducer module into a target object, the coupling shoe comprising a transducer engaging portion; a couplant chamber arranged to hold couplant; and a flexible membrane at least partially defining a probe surface for facing the target object through which couplant from the couplant chamber can seep for coupling ultrasound transmitted by the transducer module into the target object.

### CROSS-REFERENCE TO RELATED APPLICATIONS

This application is the national stage entry of International Patent Application No. PCT/EP2021/050863, filed on Jan. 15, 2021, and claims priority to Application No. GB2000723.3, filed in the United Kingdom on Jan. 17, 2020, the disclosures of which are incorporated by reference thereto.

### FIELD OF THE INVENTION

This invention relates to an ultrasound coupling shoe for coupling ultrasound between an ultrasound transducer and a target object. In particular, the present disclosure relates to a coupling shoe having a couplant chamber for holding couplant.

The coupling shoe is for attachment to a transducer module to couple ultrasound transmitted by the transducer module into a target object. The coupling shoe can be configured to couple ultrasound emitted by the transducer module into the target object and to couple reflections received from the object into the transducer module.

The transducer module is suitably for imaging an object, for instance for imaging structural features below an object's surface. The transducer module may be particularly useful for imaging sub-surface material defects such as delamination, debonding and flaking.

### BACKGROUND

Ultrasound can be used to identify particular structural features in an object. For example, ultrasound may be used for non-destructive testing by detecting the size and position of flaws in a sample. There are a wide range of applications that can benefit from non-destructive testing, covering different materials, sample depths and types of structural feature, such as different layers in a laminate structure, impact damage, boreholes etc.

Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled. It is desirable to increase the ultrasound coupling efficiency between an ultrasound transducer and an object under test.

### SUMMARY

According to an aspect of the present invention, there is provided a coupling shoe for attachment to a transducer module to couple ultrasound transmitted by the transducer module into a target object, the coupling shoe comprising: a transducer engaging portion; a couplant chamber arranged to hold couplant; and a flexible membrane at least partially defining a probe surface for facing the target object through which couplant from the couplant chamber can seep for coupling ultrasound transmitted by the transducer module into the target object.

The membrane may define substantially the whole of the probe surface. The membrane may define at least a portion of the couplant chamber. The membrane may be porous and/or comprise a plurality of holes. The plurality of holes may be arranged over substantially the whole of the membrane.

The dimensions of the holes may be in the range of 50 μm maximum width to 1000 μm maximum width. The density of holes in the membrane may be in the range of 1 hole per square mm to 1 hole per square cm.

The membrane may be disposed away from an ultrasound transmission path.

The couplant chamber may be in communication with a couplant source. The coupling shoe may comprise an inlet port in communication with the couplant chamber for supplying couplant to the chamber. The coupling shoe may comprise an outlet port in communication with the couplant chamber through which couplant can flow out of the couplant chamber.

The coupling shoe may comprise a contact-sensitive actuator for controlling couplant delivery to the couplant chamber. The inlet port may comprise the contact-sensitive actuator. The contact-sensitive actuator may be configured to control delivery of couplant in response to detecting a force that exceeds a threshold contact force.

A portion of the coupling shoe peripheral to the membrane may comprise a resilient portion.

The transducer engaging portion may comprise a transducer coupling surface for abutment to an ultrasound-emitting surface of the transducer module to couple ultrasound into the coupling shoe. The transducer engaging portion may be configured to mount the coupling shoe to the transducer module in a plurality of positions. The transducer engaging portion may be configured to mount the coupling shoe to the transducer module at a plurality of orientations. The transducer engaging portion may comprise a friction fit mechanism.

According to another aspect of the present invention, there is provided a coupling shoe for attachment to a transducer module to couple ultrasound transmitted by the transducer module into a target object, the coupling shoe comprising: a transducer engaging portion; a couplant chamber arranged to hold couplant for coupling ultrasound transmitted by the transducer module into the target object, the couplant chamber having an outlet for dispensing couplant to an interface with the target object; and an inlet in communication with the couplant chamber for supplying couplant to the couplant chamber, the inlet comprising a contact-sensitive actuator for controlling couplant delivery to the couplant chamber.

According to another aspect of the present invention, there is provided a coupling shoe for attachment to a transducer module to couple ultrasound transmitted by the transducer module into a target object, the coupling shoe comprising: a couplant chamber arranged to hold couplant for coupling ultrasound transmitted by the transducer module into the target object, the couplant chamber having an outlet for dispensing couplant to an interface with the target object; and an engagement mechanism for engaging the transducer module to hold it directed into the couplant chamber, the engagement mechanism being arranged to hold the transducer module relative to the couplant chamber in at least two different positions.

According to another aspect of the present invention, there is provided a coupling shoe for attachment to a transducer module to couple ultrasound transmitted by the transducer module into a target object, the coupling shoe comprising: a couplant chamber arranged to hold couplant for coupling ultrasound transmitted by the transducer module into the target object, the couplant chamber having an outlet for dispensing couplant to an interface with the target object; the outlet being provided on a probe surface for facing the target object.

The outlet may be provided at or towards a periphery of the probe surface of the coupling shoe. The coupling shoe may be configured to couple ultrasound transmitted by the transducer module into the target object along a transmission path, and the outlet may be provided away from the transmission path. Suitably, the transmission path is directly through the coupling shoe. The transmission path may be perpendicular to a plane in which the transducer module is held by the coupling shoe. The coupling shoe may be configured to hold the transducer module so that an ultrasound-emitting surface of the transducer module is arranged along a first plane, and the transmission path is generally perpendicular to the first plane.

The couplant chamber may comprise a plurality of outlets on the probe surface. At least some of the plurality of outlets may be provided at or towards the periphery of the probe surface. Preferably all of the plurality of outlets may be provided at or towards the periphery. The plurality of outlets may each be provided away from the transmission path. The plurality of outlets may be provided symmetrically about the coupling shoe. The coupling shoe may have a polygonal outer shape, and a respective outlet may be provided in respect of each face of the polygon. A plurality of outlets may be provided in respect of one or more faces of the polygon.

The couplant chamber may be provided away from the transmission path. Suitably the couplant chamber comprises a channel at least partially encompassing a portion of the coupling shoe forming the transmission path. The couplant chamber may surround the portion of the coupling shoe forming the transmission path.

According to another aspect of the present invention, there is provided a coupling shoe for attachment to a transducer module to couple ultrasound transmitted by the transducer module into a target object, the coupling shoe comprising: a couplant chamber arranged to hold couplant for coupling ultrasound transmitted by the transducer module into the target object, the couplant chamber having an outlet for dispensing couplant to an interface with the target object; the coupling shoe being configured to reduce bubble formation in couplant flowing through the coupling shoe, and comprising a flow-regulating feature configured to decrease turbulent flow in couplant flowing through the coupling shoe. Suitably the flow-regulating feature comprises a bubble suppression feature.

The flow-regulating feature may comprise one or more chamfered portions, thereby reducing the angle of at least one corner past which the couplant is configured to flow. The flow-regulating feature may comprise one or more smoothly curved portions, thereby reducing the number of corners and/or the angle of a corner, past which the couplant is configured to flow. The flow-regulating feature may comprise an aperture with rounded edges. The flow-regulating feature may comprise a flow rate modulator to reduce the speed of flow of couplant, thereby reducing turbulent flow. The flow rate modulator may comprise an aperture and/or a passage with an increasing width along a flow direction through the aperture or passage. The flow-regulating feature may comprise a smooth surface.

According to another aspect of the present invention, there is provided a scanning apparatus comprising a coupling shoe as described herein and a transducer module. The scanning apparatus may comprise a couplant source. The scanning apparatus may comprise a controller configured to control the pressure of couplant in the couplant chamber in dependence on one or more of ambient pressure, a velocity of the coupling shoe relative to the target object, temperature of couplant in the couplant chamber, ambient temperature and an amplitude of a peak in an ultrasound scan. The scanning apparatus may comprise a controller configured to control the flow rate of couplant into and/or out of the couplant chamber in dependence on one or more of ambient pressure, a velocity of the coupling shoe relative to the target object, temperature of couplant in the couplant chamber, ambient temperature and an amplitude of a peak in an ultrasound scan.

Any one or more feature of any aspect above may be combined with any other aspect. These have not been written out in full here merely for the sake of brevity.

### BRIEF DESCRIPTION OF THE FIGURES

The present invention will now be described by way of example with reference to the accompanying drawings. In the drawings:

FIG. 1 shows a device for imaging an object;

FIG. 2 shows an example of a scanning apparatus and an object;

FIG. 3 shows an example of the functional blocks of a scanning apparatus;

FIG. 4 shows a schematic illustration of a transducer module;

FIG. 5 shows an example of a coupling shoe engaged with a transducer module;

FIGS. 6a and 6b show examples of resilient portions at an end of a side wall of the coupling shoe;

FIG. 7 shows another example of a coupling shoe engaged with a transducer module;

FIG. 8 shows another example of a coupling shoe engaged with a transducer module;

FIG. 9 shows an example of a scanning apparatus comprising a couplant source adjacent a coupling shoe;

FIG. 10 shows an example of a scanning apparatus comprising a couplant source remote from a coupling shoe;

FIG. 11 shows an example of a coupling shoe with an outlet port;

FIG. 12 shows an example of a coupling shoe with electronic contact-sensitive actuation;

FIG. 13 shows an example of a coupling shoe with mechanical contact-sensitive actuation;

FIG. 14a shows a bottom view of another example of a coupling shoe;

FIG. 14b shows a side view of the coupling shoe of FIG. 14a;

FIG. 15 shows an example of a coupling shoe having a blister;

FIGS. 16a and 16b show examples of coupling shoes having a blister;

FIG. 17 shows another example of a coupling shoe engaged with a transducer module;

FIGS. 18a and 18b show perspective views of the coupling shoe of FIG. 17;

FIG. 19 shows a perspective view of another example of a coupling shoe;

FIG. 20 shows another example of a coupling shoe; and

FIGS. 21a-21c show different views of the coupling shoe of FIG. 20.

### DETAILED DESCRIPTION

A scanning apparatus can be used for imaging an object. The scanning apparatus comprises an ultrasound transducer, such as a transducer module, with a transmitter configured to transmit ultrasound signals in a first direction towards a target object and a receiver configured to receive reflected ultrasound signals from an object. Analysis of the reflected ultrasound received from the object can be used to analyse the object. Detection of the reflections permits analysis of the subsurface structure of the object.

An increase in detail and/or accuracy can be obtained where a greater amount of ultrasound energy is transmitted into the target object. A greater amount of energy transmitted into the target object can increase the amount of energy in reflected pulses.

In the present techniques a couplant is provided to enhance the efficiency with which ultrasound energy is coupled into the target object. The couplant forms a layer between the transducer module and the target object. A coupling shoe is attachable to the transducer module and comprises a couplant chamber for holding the couplant. The coupling shoe is configured to permit the couplant to be emitted towards the target object so that the ultrasound transmitted by the transducer module passes through the couplant (e.g. through a couplant film on the surface of the target object), before reaching the target object. Similarly, reflected pulses can travel from the surface of the target object through the couplant towards the transducer module where they are detected.

The couplant provides a material which can displace at least some of the air between the transducer and the target object. The couplant suitably has an acoustic impedance which reduces acoustic boundary reflections between the transducer module and the target object. For example, the couplant can have an acoustic impedance which is between the acoustic impedance of the surface of the transducer module and the surface of the target object, or is close to the acoustic impedance of one of the surface of the transducer module and the surface of the target object.

Suitably the coupling shoe comprises a flexible membrane which can at least partially define a probe surface for facing the target object. The membrane can be porous and/or can have a plurality of holes therein. The membrane is suitably liquid permeable. Couplant from the couplant chamber can seep through the membrane. In this way, as the coupling shoe is pressed against the target object the couplant will be provided between the transducer module and the target object.

The coupling shoe may comprise an inlet in communication with a couplant chamber for supplying couplant to the couplant chamber. The inlet can comprise a contact-sensitive actuator for controlling couplant delivery to the couplant chamber. The contact-sensitive actuator is configured so that couplant can be delivered to the couplant chamber on detecting contact between the coupling shoe and the target object. This approach enables couplant to be present in the couplant chamber when needed for an ultrasound scanning process, but reduces the risk of couplant wastage when the coupling shoe is not in use.

The coupling shoe can comprise an engagement mechanism for engaging the transducer module to hold it directed into the couplant chamber. The engagement mechanism is arranged to hold the transducer module fixed relative to the couplant chamber in at least two different positions. The transducer module can be held in different positions relative to the chamber so as to vary the ultrasound transmission distance and/or angle through the couplant and/or through the coupling shoe.

For instance, the engagement mechanism can engage the transducer module such that the transducer module protrudes by a varying distance into the coupling shoe. This permits a variation of the ultrasound transmission path length through the coupling shoe. The transducer module can be mounted such that ultrasound is transmitted through the couplant chamber towards the target object. The amount by which the transducer module protrudes within the couplant chamber can be varied. In this way, the ultrasound transmission path length through the couplant within the couplant chamber can be varied. The varying path length permits control of the ultrasound transmission time, or delay, which can allow control of the time needed for the transducers to switch from transmitting to receiving and/or to enable time-gating to remove undesirable reflections, such as the penetration echo, from the pulse signals for analysis.

Combinations of the above approaches are possible. Further detail is provided elsewhere herein.

A scanning apparatus can comprise the transducer module and the coupling shoe. The scanning apparatus may gather information about structural features located different depths below the surface of an object. One way of obtaining this information is to transmit sound pulses at the object and detect any reflections. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure the operator wants to look at is beneath the object's surface. It is therefore important that the information is imaged in such a way that the operator can evaluate the object's structure effectively.

Ultrasound transducers make use of a piezoelectric material, which is driven by electrical signals to cause the piezoelectric material to vibrate, generating the ultrasound signal. Conversely, when a sound signal is received, it causes the piezoelectric material to vibrate, generating electrical signals which can be detected.

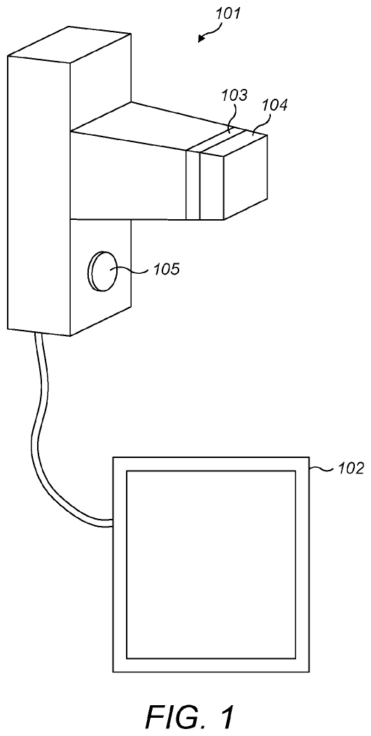

An example of a handheld device, such as a scanning apparatus described herein, for imaging below the surface of an object is shown in FIG. 1. The device 101 could have an integrated display, but in this example it outputs images to a tablet computer 102. The connection with the tablet could be wired, as shown, or wireless. The device has a matrix array 103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus as illustrated comprises a coupling layer such as a dry coupling layer 104 for coupling ultrasound signals into the object. The coupling layer also delays the ultrasound signals to allow time for the transducers to switch from transmitting to receiving. The coupling layer need not be provided in all examples. The scanning apparatus can comprise a coupling shoe as will be described elsewhere herein attached to the front of the transducer.

The matrix array 103 is two dimensional so there is no need to move it across the object to obtain an image. A typical matrix array might be approximately 30 mm by 30 mm but the size and shape of the matrix array can be varied to suit the application. The device may be straightforwardly held against the object by an operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 105 or other user input device that the operator can use to change the pulse shape and corresponding filter. In other examples the dial need not be provided. Selection of the pulse shape and/or filter can be made in software. The most appropriate pulse shape may depend on the type of structural feature being imaged and where it is located in the object. The operator can view the object at different depths by adjusting the time-gating via the display. Having the apparatus output to a handheld display, such as the tablet 102, or to an integrated display, is advantageous because the operator can readily move the transducer over the object, or change the settings of the apparatus, depending on what is seen on the display and get instantaneous results. In other arrangements, the operator might have to walk between a non-handheld display (such as a PC) and the object to keep rescanning it every time a new setting or location on the object is to be tested.

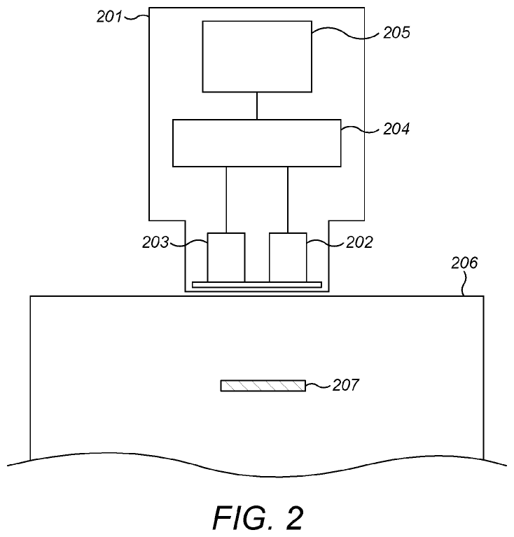

A scanning apparatus for imaging structural features below the surface of an object is shown in FIG. 2. The apparatus, shown generally at 201, comprises a transmitter 202, a receiver 203, a signal processor 204 and an image generator 205. In some examples the transmitter and receiver may be implemented by an ultrasound transducer. The transmitter and receiver are shown next to each other in FIG. 2 for ease of illustration only. The transmitter 202 is suitably configured to transmit a sound pulse having a particular shape at the object to be imaged 206. The receiver 203 is suitably configured to receive reflections of transmitted sound pulses from the object. A sub-surface feature of the object is illustrated at 207.

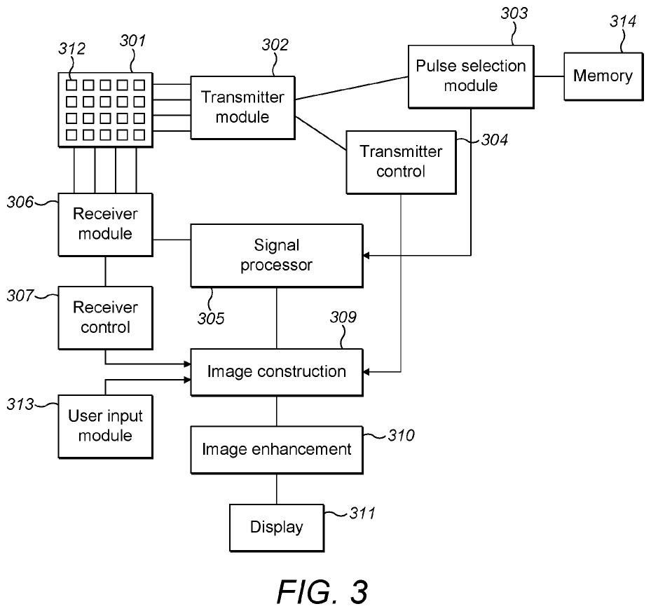

An example of the functional blocks comprised in one embodiment of the apparatus are shown in FIG. 3. In this example the transmitter and receiver are implemented by an ultrasound transducer 301, which comprises a matrix array of transducer elements 312. The transducer elements transmit and/or receive ultrasound waves. The matrix array may comprise a number of parallel, elongated electrodes arranged in an intersecting pattern; the intersections form the transducer elements. The transmitter electrodes are connected to the transmitter module 302, which supplies a pulse pattern with a particular shape to a particular electrode. The transmitter control 304 selects the transmitter electrodes to be activated. The number of transmitter electrodes that are activated at a given time instant may be varied. The transmitter electrodes may be activated in turn, either individually or in groups. Suitably the transmitter control causes the transmitter electrodes to transmit a series of sound pulses into the object, enabling the generated image to be continuously updated. The transmitter electrodes may also be controlled to transmit the pulses using a particular frequency. The frequency may be between 100 kHz and 30 MHz, preferably it is between 0.5 MHz and 15 MHz and most preferably it is between 0.5 MHz and 10 MHz.

The receiver electrodes sense sound waves that are emitted from the object. These sound waves are reflections of the sound pulses that were transmitted into the object. The receiver module receives and amplifies these signals. The signals are sampled by an analogue-to-digital converter. The receiver control suitably controls the receiver electrodes to receive after the transmitter electrodes have transmitted. The apparatus may alternately transmit and receive. In one embodiment the electrodes may be capable of both transmitting and receiving, in which case the receiver and transmitter controls will switch the electrodes between their transmit and receive states. There is preferably some delay between the sound pulses being transmitted and their reflections being received at the apparatus. The apparatus may include a coupling layer (such as the dry coupling and/or as provided by the coupling shoe) to provide the delay needed for the electrodes to be switched from transmitting to receiving. Any delay may be compensated for when the relative depths are calculated. The coupling layer preferably provides low damping of the transmitted sound waves.

Each transducer element may correspond to a pixel in the image. In other words, each pixel may represent the signal received at one of the transducer elements. This need not be a one-to-one correspondence. A single transducer element may correspond to more than one pixel and vice-versa. Each image may represent the signals received from one pulse. It should be understood that “one” pulse will usually be transmitted by many different transducer elements. These versions of the “one” pulse might also be transmitted at different times, e.g. the matrix array could be configured to activate a “wave” of transducer elements by activating each line of the array in turn. This collection of transmitted pulses can still be considered to represent “one” pulse, however, as it is the reflections of that pulse that are used to generate a single image of the sample. The same is true of every pulse in a series of pulses used to generate a video stream of images of the sample.

The pulse selection module 303 selects the particular pulse shape to be transmitted. It may comprise a pulse generator, which supplies the transmitter module with an electronic pulse pattern that will be converted into ultrasonic pulses by the transducer. The pulse selection module may have access to a plurality of predefined pulse shapes stored in a memory 314. The pulse selection module may select the pulse shape to be transmitted automatically or based on user input. The shape of the pulse may be selected in dependence on the type of structural feature being imaged, its depth, material type etc. In general the pulse shape should be selected to optimise the information that can be gathered by the signal processor 305 and/or improved by the image enhancement module 310 in order to provide the operator with a quality image of the object.

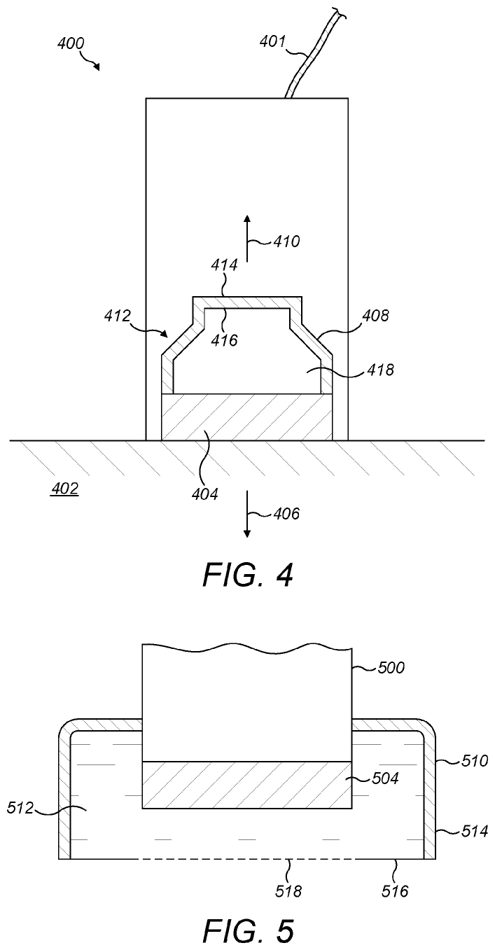

FIG. 4 schematically illustrates a transducer module. The transducer module (TRM) is generally indicated at 400. An electrical connection such as a cable 401 couples the TRM to a remote system. The remote system can provide driving signals and can receive detected signals. The transducer module is shown as being placed against an object under test 402. The TRM comprises a transducer 404. The transducer 404 comprises a transmitter. The transducer comprises a receiver. The transmitter and receiver may be separately provided. Details of the transducer structure and its electrical connections are omitted from this figure for clarity. The transducer is configured to transmit ultrasound signals towards the object to be imaged. The transducer is suitably configured to transmit ultrasound signals in a direction indicated at 406.

FIG. 5 illustrates a coupling shoe attached to a transducer module 500. The coupling shoe suitably comprises a transducer engaging portion for engaging with a transducer module. The transducer engaging portion can comprise an engagement mechanism. The coupling shoe comprises a couplant chamber 512 for holding couplant, such as water or coupling gel. Any other suitable liquid couplant can be used. The couplant chamber is bounded by side walls 514 and a flexible membrane 516. The membrane defines a probe surface for facing a target object.

The membrane is configured so that couplant can pass through the membrane. For example, the membrane can be configured so that couplant can seep through the membrane. The rate at which couplant can pass through the membrane is suitably selectable. For example, the material or configuration of the membrane can be selected to achieve a desired rate of couplant passage. The rate of couplant passage can be dependent on the properties of the couplant, such as its temperature, viscosity, density and pressure. The rate of couplant passage can be dependent on the pressure difference between the couplant in the couplant chamber and an ambient pressure outside the coupling shoe adjacent the membrane. The rate of couplant passage can be dependent on the temperature of the couplant in the couplant chamber and/or on an ambient temperature outside the coupling shoe.

The flexible membrane permits conformity to a surface of the target object against which the coupling shoe is pressed. This allows the probe surface of the coupling shoe to conform to the surface of the target object to more effectively couple ultrasound into the target object. As the membrane conforms to the surface, and couplant is allowed to pass or seep through the membrane, the couplant is provided between the transducer module and the surface of the target object. Thus, the flexible membrane permits the couplant to be provided across the surface of the target object for a wide variety of surface profiles of the target object.

The membrane can comprise vinyl, latex, Teflon or some combination of two or more of these materials. Other flexible materials may also be suitable.

Suitably the membrane is porous and/or permeable, such as liquid permeable. The couplant may thus seep through pores (or holes) in the membrane. The membrane can comprise a plurality of holes enabling couplant to seep through the membrane. The holes can be provided in the material of the membrane by puncturing the membrane material with one or more needles of a specified size. In this way, selection of a particularly-sized needle or needles enables control over the size of the holes in the membrane. This permits control over the seepage rate of couplant through the membrane.

Suitably the holes are arranged over substantially the whole of the membrane. In some cases the holes can be provided over a portion of the membrane facing the transducer module. This is illustrated in FIG. 5. The portion of the membrane 516 close to the side walls 514 of the coupling shoe 510 is schematically shown as not comprising any holes (though it might instead comprise holes of smaller size, lower area density and so on). The portion of the membrane 518 directly underneath (in the orientation of this figure) the transducer module is schematically shown as comprising holes (though it might instead comprise holes of greater size, greater area density and so on). In an alternative, the portion of the membrane facing the transducer module, i.e. directly underneath (in the orientation of FIG. 5) the transducer module, can be free of holes. The holes can instead be provided in a remaining portion of the membrane, i.e. a portion close to the side walls of the coupling shoe. The portion of the membrane directly underneath the transducer module can be provided with a number and/or density and/or size of holes that is smaller than for the remaining portion of the membrane.

The holes or pores in the membrane can be provided in a particular pattern in the membrane. The pattern may be a repeating pattern, such as a grid of holes, which might be a polygonal grid. The grid may be a square or rectangular grid. The holes or pores may be provided randomly across at least a portion of the area of the membrane.

The holes are suitably formed of uniform dimensions, or with a distribution within a particular dimension range. For example, the maximum width of the holes can be the same, or substantially the same. The holes can be of uniform shape, such as circular or substantially circular. The holes may be oval. In some cases, the holes can be of differing shapes and/or dimensions. The maximum width can be in a range of 50 μm to 1000 μm.

The density of holes in the membrane is suitably in the range of 1 hole per square mm to 1 hole per square cm. The density of holes may be less than 1 per square cm.

The couplant chamber need not be large. It is sufficient for the chamber to hold enough couplant to enable a couplant film to be provided between the probe surface and the target object as the coupling shoe is pressed against the target object. In most cases, a relatively small amount of couplant will be enough to achieve this, for example less than about 5 ml. Suitably the couplant chamber is equal to or less than about 5 ml in volume, about 2 ml in volume, about 1 ml in volume, about 0.5 ml in volume. Suitably the couplant chamber is about 0.2 ml in volume to about 0.5 ml in volume. The couplant chamber may be about 0.2 ml in volume to about 1 ml in volume.

As illustrated in FIG. 5, the membrane 516 defines a part of the couplant chamber 512. The membrane can define one face of the couplant chamber.

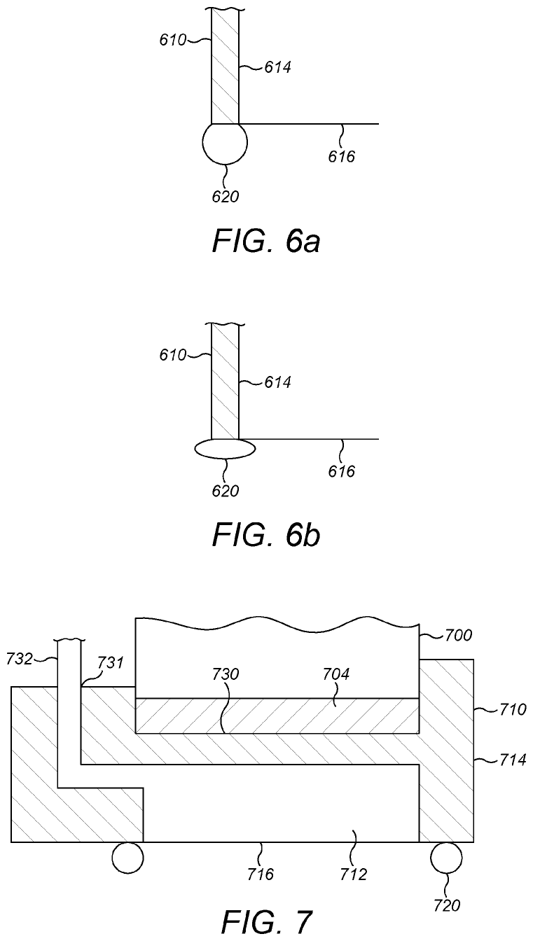

Referring now to FIG. 6a, the coupling shoe comprises a resilient portion 620 adjacent or near to the membrane 616. As illustrated the resilient portion is provided at an end of the side walls 614 of the coupling shoe. The resilient portion can comprise a resilient material coupled to or forming part of the side walls of the coupling shoe. FIG. 6a illustrates a flexible sac attached to the end of the side walls 614. The sac may be of a resilient material. The sac may be a fluid-filled sac, comprising flexible walls. On pressing the coupling face of the coupling shoe against a target object, the resilient portion can be compressed between the remainder of the shoe and the target object. This compression of the sac 620 is illustrated in FIG. 6b. Thus, a seal can usefully be formed between the coupling shoe and the target object and this seal can assist to retain couplant adjacent the probe surface of the coupling shoe.

The resilient portion can be for accommodating surface variations in the target object. The resilient portion is suitably configured to at least partially seal between the coupling shoe and the target object, thereby helping to retain the couplant that has seeped through the membrane. The side walls 614 of the coupling shoe 610 can at least partially define the couplant chamber. Suitably the side walls are provided exterior to the couplant chamber. At least a portion of the side walls can be of a resilient material.

The resilient portion may be formed from one or more of aqualene, aquasealux, a rubber, and an elastomer. The resilient portion may take the form of a fluid-filled sac or an O-ring.

The side walls, or a remainder of the side walls, can be formed of a less resilient material, such as rexolite.

The transducer engaging portion can comprise a transducer coupling surface for abutment to an ultrasound-emitting surface of the transducer module to couple ultrasound into the coupling shoe. With reference to FIG. 7, the transducer coupling surface 730 can form a portion of a recess in the coupling shoe 710 into which the transducer module 710 is receivable. The transducer coupling surface can provide structural stability to the coupling shoe. As illustrated in FIG. 7, the transducer coupling surface can be unitary with a remainder of the coupling shoe structure. This need not be the case. In some cases, the transducer coupling surface can be coupled to a portion of the coupling shoe such as a side wall 714 by a gasket, e.g. an elastomeric gasket, a rubber gasket, a metal gasket, a fibrous gasket and so on.

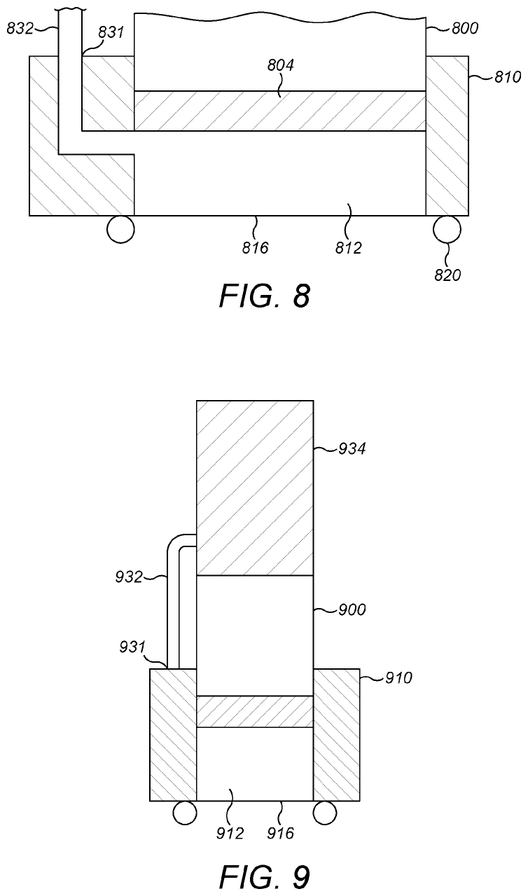

In other cases, an example of which is illustrated in FIG. 8, a transducer coupling surface need not be provided. The transducer engaging portion of the coupling shoe 810 can engage with a side of the transducer module 800. For example, the engagement mechanism can be configured to engage with the transducer module. The engagement with the transducer module can be in the form of any one or more of a friction fit, a clip engagement, a snap-fit engagement, a gripping or clamping engagement, a sliding engagement, and so on. The front, ultrasound-emitting surface of the transducer module can be in contact with couplant in the couplant chamber 812. This arrangement can reduce the number of interfaces between the transducer module and the target object. By a comparison between FIGS. 7 and 8 it can be seen that the arrangement of FIG. 8 avoids the presence of the interface from the transducer module into the transducer coupling surface, and the subsequent interface into the couplant chamber.

As couplant from the couplant chamber seeps through the membrane, or otherwise leaves the couplant chamber, it is desirable to replace the lost couplant or to replenish the couplant in the couplant chamber.

Referring again to FIGS. 7 and 8, the coupling shoe is configured to be in communication with a couplant source. The couplant chamber is in communication with the couplant source. The couplant chamber is in fluid communication with the couplant source. The couplant chamber is able to communicate with the couplant source thereby to replenish couplant in the chamber. The couplant chamber communicates with the couplant source to replace couplant seeping out of the chamber through the membrane.

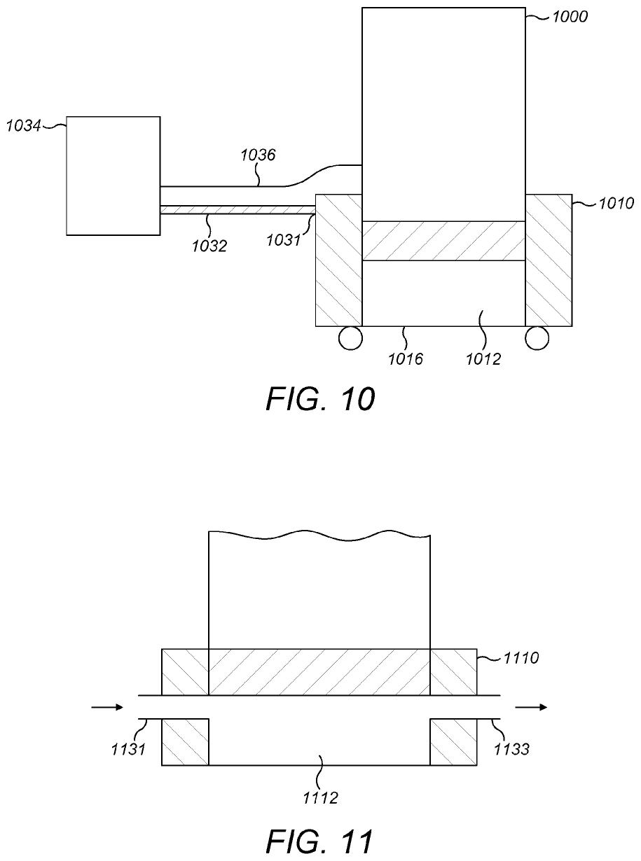

The couplant source may be near to or adjacent the couplant chamber, or the couplant source may be remote from the couplant chamber. The couplant source may be remote from the coupling shoe. For instance, the couplant source 934, 1034 can be mounted at the scanning apparatus, i.e. at or adjacent the coupling shoe 910 (see FIG. 9). The couplant source can be provided remote from the coupling shoe and transducer module, such as by being provided in or as part of a separate module (see FIG. 10).

The coupling shoe comprises an inlet port 731, 831, 931, 1031 in communication with the couplant chamber for supplying couplant to the chamber. The inlet port can be coupled to a tube 732, 832, 932, 1032 for connecting the couplant chamber to the couplant source 934, 1034, for example a remote couplant source. In this way couplant can be provided to the couplant chamber. The inlet port may couple the couplant chamber to the couplant source. This can reduce the size of the system and/or the potential pressure drop between the couplant source and the couplant chamber which might otherwise occur across the length of the tube. Whilst FIGS. 7 to 10 illustrate coupling shoes with a single inlet port, in other examples multiple inlet ports can be provided. Each inlet port may be coupled to a different couplant source, or multiple inlet ports can couple to a single couplant source.

The couplant source 1034 can be provided at a location together with a remote processor or other electronic control. Thus an electrical wire 1036 can conveniently pass alongside the tube 1032.

Referring now to FIG. 11, the coupling shoe can comprise an outlet port 1133 in communication with the couplant chamber 1112 through which couplant can flow out of the couplant chamber. Multiple outlet ports can be provided as desired. The outlet port provides an additional outlet flow path for couplant from the couplant chamber. This additional flow path can be used to adjust or control pressure within the couplant chamber. For example, where it is desired to reduce the pressure of couplant within the couplant chamber more quickly than might be possible by waiting for couplant to seep out of the couplant chamber, the outlet port enables this to be achieved. Couplant can be removed from the couplant chamber through the outlet port by causing a pressure drop downstream of the outlet port. A pump can be provided to provide such a pressure drop.

The outlet port also enables couplant to be preserved. Where the coupling shoe is removed from the target object, couplant in the couplant chamber may still pass out from the chamber. This can lead to a wastage of couplant. The outlet port provides a mechanism whereby couplant can be removed from the chamber and recycled. For example, the removed couplant can be returned to the couplant source.

The coupling shoe can comprise a contact-sensitive actuator for controlling couplant delivery to the couplant chamber. This permits couplant to be provided to the chamber as it is needed, and so can help reduce couplant wastage. The contact-sensitive actuator can be provided in the flow path between the couplant source and the couplant chamber so as to control the flow of couplant towards the couplant chamber. For example, the contact-sensitive actuator can be provided as part of the coupling shoe. In some cases, the inlet port can comprise the contact-sensitive actuator.

The actuator is suitably actuatable on, or in response to, contact between the coupling shoe and the target object. The coupling shoe can be configured to sense or detect contact between the coupling shoe and the target object. The coupling shoe can be configured to sense or detect a force with which the coupling shoe is pressed against the target object. For example, the coupling shoe can comprise a contact sensor for sensing contact between the coupling shoe and the target object. The contact sensor can comprise a light sensor for sensing when the coupling shoe is brought against another object. The light sensor can comprise an LED sensor and/or a laser sensor. The contact sensor suitably comprises a force sensor for sensing the force with which the coupling shoe is pressed against the target object. The contact-sensitive actuator can comprise the contact sensor such as the force sensor and/or be responsive to a sensed contact and/or a sensed force.

The contact-sensitive actuator is suitably configured to control delivery of couplant in response to detecting a force that exceeds a threshold contact force. The threshold contact force can be selected as desired, for example by a user.

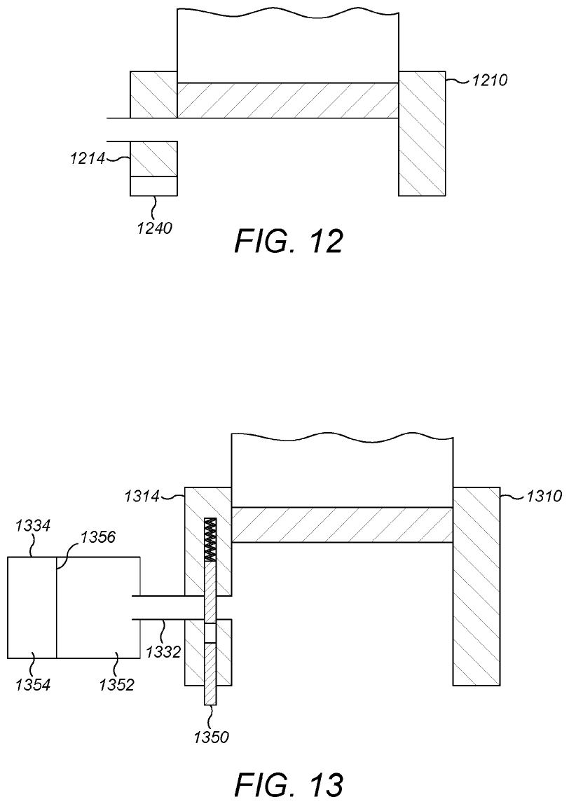

The contact-sensitive actuator may be electronically controllable, for example as illustrated in FIG. 12. A contact sensor 1240 can be provided at a distal end of a side wall 1214 of the coupling shoe 1210 for sensing contact between the coupling shoe and a target object. The contact sensor can be communicatively linked to a control system (not shown) by a wired and/or wireless connection. In response to detecting contact, the control system can control the actuator to deliver couplant to the chamber.

The actuator can be configured to deliver couplant by controlling a valve between the couplant source and the couplant chamber. The actuator can be configured to deliver couplant by controlling a pump, such as a displacement pump. The actuator can be configured to deliver couplant by controlling an amount by which a movable actuation element can move, for example the distance by which a linear actuation element can move or the angle through which a rotatable actuation element can move. The actuatable element can, for example, form part of a syringe-type delivery system in which the actuatable element is coupled to or forms the plunger, and couplant is held in the barrel.

The contact sensor can comprise the force sensor for sensing the force with which the coupling shoe is pressed against the target object. In response to detecting a force above the threshold contact force, the control system can control the actuator to deliver couplant to the chamber.

The contact-sensitive actuator may be mechanically controllable. An example of such mechanical control is illustrated in FIG. 13. The coupling shoe 1310 is provided with the contact-sensitive actuator 1350 housed, in this example, in a side wall 1314 of the shoe. The actuator comprises a valve having an opening, the valve being movable between extended and recessed positions. A biasing member, such as a spring, biases the valve towards the extended position. The valve is movable in a channel so as to selectively block or open a passage towards the chamber. As illustrated, the passage passes through the side wall 1314.

In the extended position, a body of the valve blocks the passage, and couplant is prevented from flowing into the chamber. In the recessed position, the opening of the valve aligns with the passage thereby enabling couplant from a couplant source to flow through the passage towards the chamber. The valve is movable from the extended position to the recessed position on pressing the coupling shoe against an object. When pressed against an object, a protruding portion of the valve contacts the object and the force of the contact acts against the biasing member to drive the valve towards the recessed position. Suitably the biasing member and valve are arranged so that the opening of the valve aligns with the passage when the force of the contact meets or exceeds the threshold contact force.

A combination of electronic and mechanical control is also possible.

The contact-sensitive actuator can be configured to deliver couplant at a selected pressure to the couplant chamber on actuation. The contact-sensitive actuator can be configured to deliver a selected volume of couplant to the couplant chamber on actuation.

Referring again to FIG. 13, the couplant source 1334 is shown as comprising two compartments. A first compartment 1352 proximal to the tube 1332 connecting the couplant source to the shoe is provided with couplant such as water. A second compartment 1354 distal to the tube 1332 is provided with a pressurised fluid. A divider 1356 between the first and second compartments is movable so as to change the relative volumes of the two compartments. On actuation of the contact-sensitive actuator, a path is opened for the couplant to flow out of the couplant source. Couplant can flow out of the first compartment under the action of the pressurised fluid in the second compartment. For example, the second compartment can contain pressurised gas such as carbon dioxide. The pressure of the gas can force the water through the tube towards the chamber, thereby charging the chamber with a volume of couplant.

The actuator and/or the couplant source may comprise a mechanism whereby the volume of couplant delivered to the couplant chamber on actuation of the actuator is limited. For example, the path may open for a particular time period. The rate at which couplant flows through the path controls the volume of couplant delivered to the couplant chamber. The path may comprise, or communicate with, a flow measurement arrangement thereby to measure the flow through the flow path. An example of the flow measurement arrangement is a displacement meter. The flow measurement arrangement may measure forces produced by the couplant flow. The flow measurement arrangement may measure the velocity of the couplant flow. Any other suitable flow measurement arrangement may be used. The flow measurement arrangements may be used alone or in any suitable combination.

The contact-sensitive actuator is suitably actuatable in response to contact between the coupling shoe and the target object so that the couplant chamber is ‘charged’ with a particular amount of couplant and/or couplant at a particular pressure as the coupling shoe is pressed against the target object. This approach enables a suitable provision of couplant to be provided for ultrasound analysis and can reduce the amount of couplant that might be lost from the coupling shoe when it is not located adjacent a target object.

Suitably, the pressure of couplant in the couplant chamber is greater than an ambient pressure. The ambient pressure can be a pressure outside the coupling shoe adjacent the membrane, for example a pressure of air surrounding the coupling shoe. Maintaining the pressure of couplant in the chamber above ambient pressure can cause the couplant to seep out through the membrane. Couplant seepage can therefore maintain a couplant film between the coupling shoe and the target object, assisting the coupling of ultrasound into the target object.

The pressure of couplant in the couplant chamber can be controllable in response to ambient pressure. Ambient pressure may be determined in response to a sensor output. The sensor may be provided on or as part of the coupling shoe. The sensor may be provided remote from the coupling shoe. The sensor may comprise a pressure sensor for sensing the ambient pressure. The sensor may determine the location of the coupling shoe, and ambient pressure may be determined by reference to a database comprising locations and corresponding ambient pressures. This can enable a pressure to be determined based on the geographic location of the test site, and a height at which the ultrasound analysis is being carried out.

A change in pressure of the couplant can affect the acoustic properties of the couplant. Therefore, enabling control of the pressure in the couplant chamber can also assist in optimising the ultrasound analysis performed using the coupling shoe.

The pressure of couplant in the couplant chamber can be controllable in response to a velocity of the coupling shoe relative to the target object. A local positioning system may control or detect movement of a scanning apparatus including the coupling shoe relative to the target object. The local positioning system may be configured to determine the relative velocity of motion between the coupling shoe and the target object, for example by monitoring rotation of a tracking ball (akin to a mouse tracking ball), by using an infra-red or radio tracking system, or by using a GPS tracking system, and so on.

The pressure of couplant in the couplant chamber will affect the seepage rate of couplant through the membrane, and hence the amount of couplant provided to couple ultrasound into the target object. As the coupling shoe moves faster relative to the target object, it is likely that a greater amount of couplant will be required to seep through the membrane to maintain a suitable coupling film thickness. This can be due to loss of couplant as the coupling shoe moves across the surface of the target object. Thus, controlling the couplant pressure in dependence on the relative motion between the coupling shoe and the target object can enable a suitable coupling film to be maintained, which in turn can help ensure that the ultrasound analysis remains effective over a range of relative speeds of motion.

The pressure of couplant in the couplant chamber can be controllable in response to ambient temperature and/or in response to temperature of couplant in the couplant chamber. Ambient temperature and/or couplant temperature may be determined in response to a temperature sensor output. The temperature sensor may be provided on or as part of the coupling shoe. The temperature sensor may be provided remote from the coupling shoe. As the temperature of the couplant increases, its viscosity can decrease, which can in turn lead to a greater seepage rate (for example where pressure of the couplant does not change). To reduce variations in the seepage rate, it can be desirable to control the pressure of couplant in the couplant chamber in response to temperature variations. For example, as temperature of couplant in the couplant chamber increases, the pressure can be decreased to maintain the same, or substantially the same, seepage rate. As the couplant temperature decreases, pressure can be increased to maintain the same, or substantially the same, seepage rate.

Suitably the scanning apparatus comprises a feedback mechanism that is configured to determine whether the coupling film thickness is suitable for the current analysis. For example, an amplitude of a selected ultrasound pulse can be monitored to assess whether ultrasound is being effectively coupled into the target object. Where the amplitude of the selected ultrasound pulse changes past a predetermined level, it can be determined that the ultrasound is less effectively coupling into the target object and remedial action can be taken in response. Such remedial action can include increasing the pressure of couplant in the couplant chamber so as to cause increased seepage of couplant through the membrane thereby providing a greater amount of couplant between the coupling shoe and the target object. Such remedial action can include decreasing the pressure of couplant in the couplant chamber so as to cause decreased seepage of couplant through the membrane thereby providing a lesser amount of couplant between the coupling shoe and the target object.

The remedial action can include controlling the flow of couplant into and/or out of the couplant chamber, thereby controlling the amount of couplant between the coupling shoe and the target object. Controlling the flow of couplant into and/or out of the couplant chamber also suitably has the effect of controlling the pressure of couplant in the couplant chamber.

The selected ultrasound pulse can comprise the penetration echo. Where the amplitude of the penetration echo increases, this can indicate that less ultrasound energy is penetrating into the target object (e.g. more ultrasound energy is reflecting from the boundary between the coupling shoe and the target object). This can be caused by a reduction in or loss of couplant between the coupling shoe and the target object. In this case, determining an increase in amplitude of the penetration echo past a penetration echo threshold can indicate that insufficient couplant is being provided. In response, the amount of couplant provided between the coupling shoe and the target object can be increased by increasing the pressure of couplant in the couplant chamber. The amount of couplant provided between the coupling shoe and the target object can be increased by increasing the flow of couplant into the couplant chamber (e.g. via an inlet port) and/or by decreasing the flow of couplant out of the couplant chamber (e.g. via an outlet port).

The selected ultrasound pulse can comprise a subsurface reflection. Where the amplitude of the subsurface reflection decreases, this can indicate that less ultrasound energy is penetrating the target object (e.g. less ultrasound energy is reflecting from a subsurface feature). This can be caused by a reduction in or loss of couplant between the coupling shoe and the target object. In this case, determining a decrease in amplitude of the subsurface reflection past a subsurface reflection threshold can indicate that insufficient couplant is being provided. In response, the amount of couplant provided between the coupling shoe and the target object can be increased by increasing the pressure of couplant in the couplant chamber. The amount of couplant provided between the coupling shoe and the target object can be increased by increasing the flow of couplant into the couplant chamber (e.g. via an inlet port) and/or by decreasing the flow of couplant out of the couplant chamber (e.g. via an outlet port).

Referring again to FIG. 5, the membrane is disposed in front of the transducer module, i.e. along an ultrasound transmission path of ultrasound emitted by the transducer module towards the target object. In arrangements in which at least a portion of the membrane is disposed along the ultrasound transmission path, at least a portion of the couplant chamber is provided generally between the transducer module and the probe surface. This need not be the case.

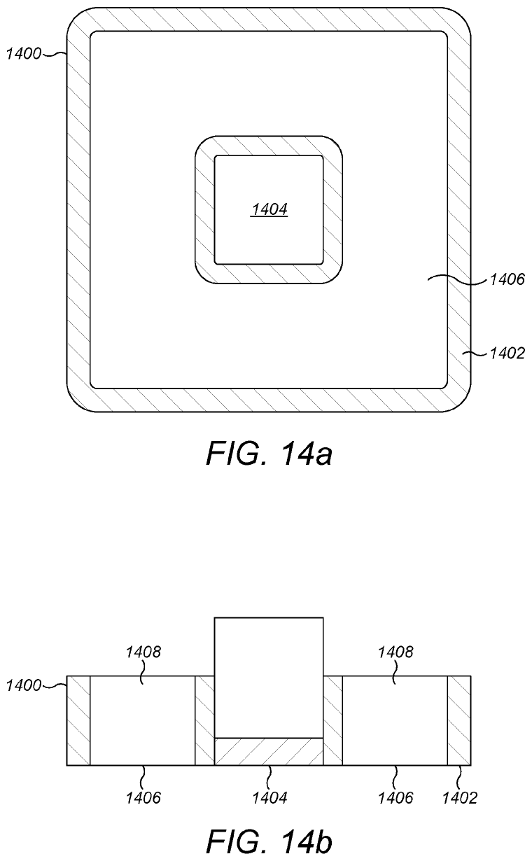

In some arrangements, the membrane can be disposed away from the ultrasound transmission path. That is to say, the membrane need not lie on a path taken by ultrasound transmitted from the transducer module towards the target object. FIGS. 14a and 14b illustrate such an arrangement. The coupling shoe 1400 is attachable to the transducer module such that a coupling shoe front surface 1402 lies generally co-planar with a transducer module front surface 1404. The coupling shoe comprises a probe surface 1406. The probe surface is at least partially defined by a flexible membrane. The coupling shoe comprises a couplant chamber 1408. As illustrated, the membrane defines a wall of the couplant chamber. The couplant chamber is, in the illustrated example, provided so as to surround the transducer module. The couplant chamber need not fully surround the transducer module. The couplant chamber may, in some examples, partially surround the transducer module. The couplant chamber may be provided to one side of the transducer module.

This arrangement permits couplant to seep through the membrane thereby to provide a couplant film between the transducer module and the target object without needing the couplant chamber to be on an ultrasound emission path of ultrasound emitted by the transducer module. Thus, the dimensions of the couplant chamber need not affect the ultrasound emission path. This approach can also have the benefit of enabling the scanning apparatus, comprising the coupling shoe and the transducer module, to be compact.

Advantageously, the couplant chamber can, in such arrangements, be provided around the transducer module, as illustrated in FIG. 14a. This approach enables couplant to seep through the membrane in such a way as to provide a suitable couplant film between the transducer module and the target object irrespective of the direction in which the scanning apparatus is moved across the surface of the target object.

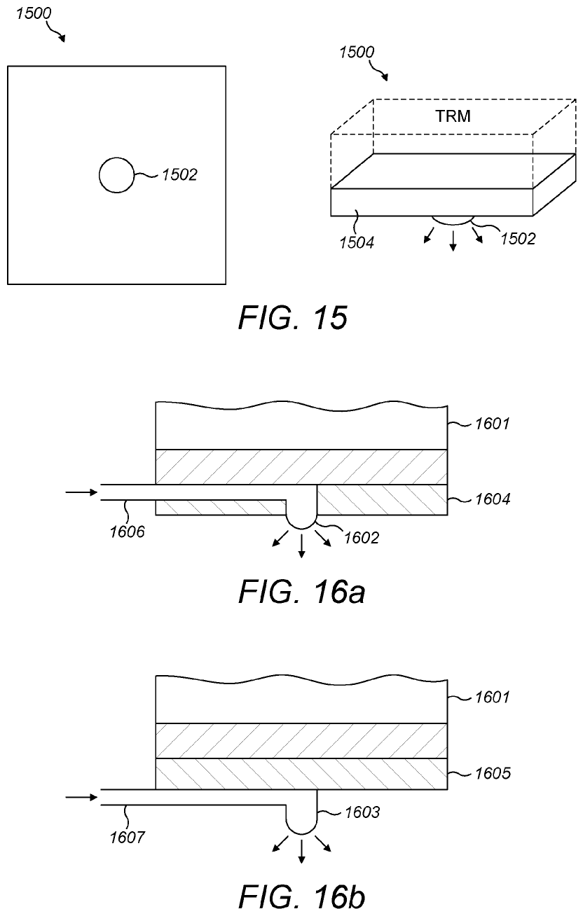

The membrane need not be provided across the whole, or even a majority, of the lower portion of the coupling shoe. The membrane can, in at least some examples, be provided in a more limited manner. Reference is now made to FIG. 15, illustrating a coupling shoe 1500 comprising a blister 1502 protruding from a plate 1504. The couplant chamber is not shown in this figure for clarity, but it will be appreciated that the couplant chamber and an inlet for providing couplant to the couplant chamber can be provided. A path from the couplant chamber to the interior of the blister 1502 can also be provided.

The blister suitably comprises a fluid-filled blister, bounded by a resilient material, such as a membrane as described elsewhere herein. Suitably the resilient material is more resilient than the material of the plate. For example, the plate can comprise rexolite.

Couplant is provided to the interior of the blister and can seep through the material. The blister can thereby provide couplant in a more limited area than at least some of the other examples of coupling shoes described herein. The coupling shoe 1500 comprising the blister is useful to image spot welds, and/or other features of a limited lateral extent.

In at least one arrangement, the blister can be a sealed blister. In such arrangements there need not be a replenishment flow path into the blister as there is no controlled seepage of couplant out from the blister.

Reference is now made to FIGS. 16a and 16b, illustrating example configurations of coupling shoes comprising blisters. The plate 1604 may comprise a recess or through-hole. The blister 1602 can protrude from such a recess or through-hole. A couplant supply passage 1606 can be provided, such as within the plate 1604, for supplying couplant to the interior of the blister. In an alternative, the blister 1603 may be provided on a surface of the plate 1605. A couplant supply passage 1607 can be provided, such as within the plate or along a surface of the plate, for supplying couplant to the interior of the blister. The plate 1604, 1605 can provide structural stability to the coupling shoe. The transducer module 1601 can be engaged with a surface of the plate 1604, 1605 opposite the surface on which or through which the blister protrudes.

As mentioned, the coupling shoe can comprise a transducer engaging portion for engaging with the transducer module, whereby the coupling shoe and transducer module are engageable in different positions relative to one another. The coupling shoe and transducer module can be engageable in different relative positions thereby to vary the transmission distance of ultrasound through the couplant and/or through the coupling shoe.

The engagement mechanism is suitably configured to engage the transducer module so as to mount the transducer module at a plurality of positions relative to the coupling shoe. The engagement mechanism is suitably configured to hold the transducer module directed into the couplant chamber, so that ultrasound emitted by the transducer module is directed into the chamber. The engagement mechanism can be configured to hold the transducer module in different relative orientations thereby to vary the transmission direction of ultrasound through the coupling shoe. The engagement mechanism can be configured to hold the transducer module at different distances from the membrane thereby to vary the transmission distance of ultrasound through the coupling shoe.

The variation of ultrasound transmission direction and/or distance enables control of the ultrasound path length and/or delay time between transmission and reception of ultrasound signals. The transmission direction and/or distance are suitably varied in dependence on the frequency of ultrasound transmitted by the transducer module (or an average frequency, or a frequency of maximum amplitude) and/or the depth of a feature of interest.

The engagement mechanism suitably comprises one or more of a friction fit mechanism, a clip engagement, a snap-fit engagement, a gripping or clamping engagement, a sliding engagement, and so on. The engagement mechanism is suitably configured to engage with sides of the transducer module. The engagement mechanism is suitably configured to sealingly engage with sides of the transducer module, so as to retain couplant in the chamber.

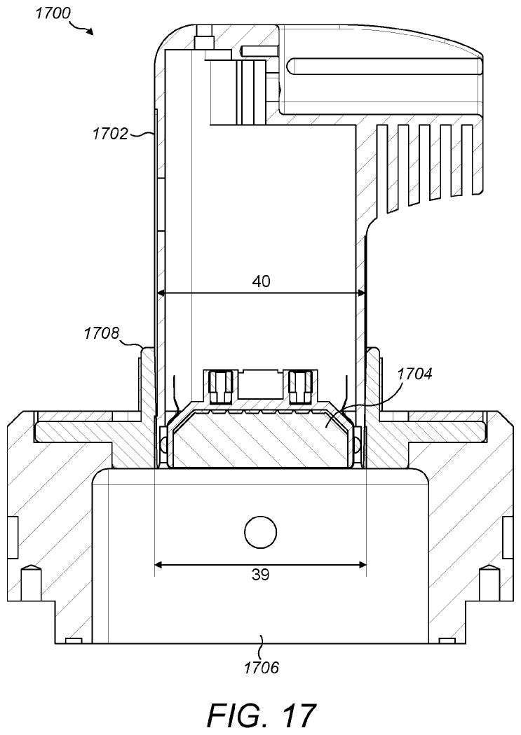

FIG. 17 illustrates a coupling shoe 1700 engaged with a transducer module 1702 having a transducer 1704. The coupling shoe comprises a couplant chamber 1706. A transducer engaging portion 1708 is provided for engaging between the coupling shoe 1700 and the transducer module 1702. An inlet for providing couplant to the couplant chamber is shown at 1710. The transducer engaging portion 1708 frictionally engages with the sides of the transducer module. Suitably the transducer engaging portion comprises a resilient portion for sealingly engaging with the transducer module. For example, the transducer engaging portion can comprise a resilient surface for pressing against the transducer module. The resilient surface can comprise an elastomer.

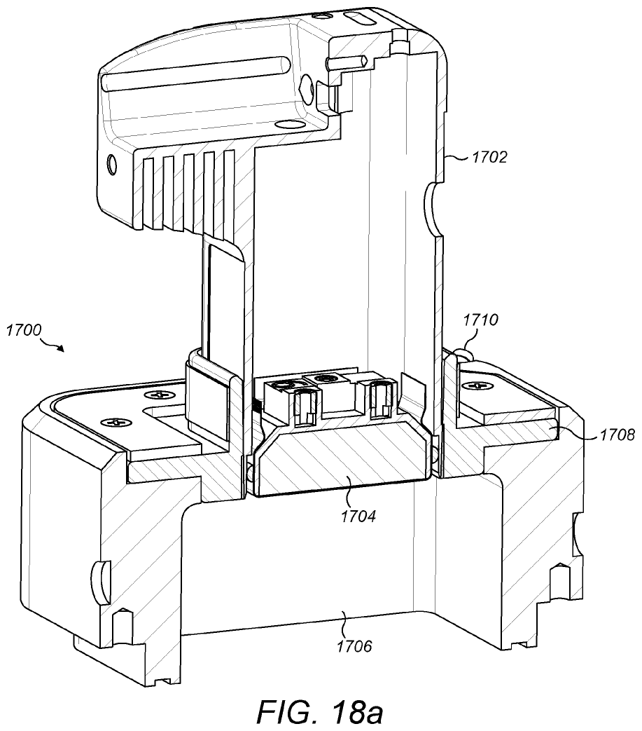

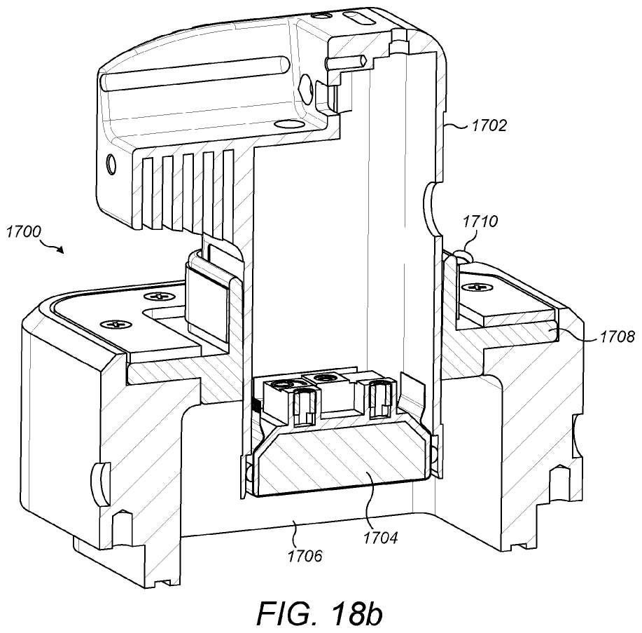

The transducer engaging portion 1708 permits the transducer module to be mounted at different heights with respect to the coupling shoe. FIG. 17 shows a transducer module mounted such that the transducer module does not protrude (or does not significantly protrude) within the couplant chamber 1706. This illustrated arrangement corresponds to that shown in FIG. 18a (showing a perspective cut-away view). Comparison between FIG. 18a and FIG. 18b shows that the transducer module can be moved relative to the coupling shoe such that the transducer module can protrude to a greater relative extent into the couplant chamber 1706.

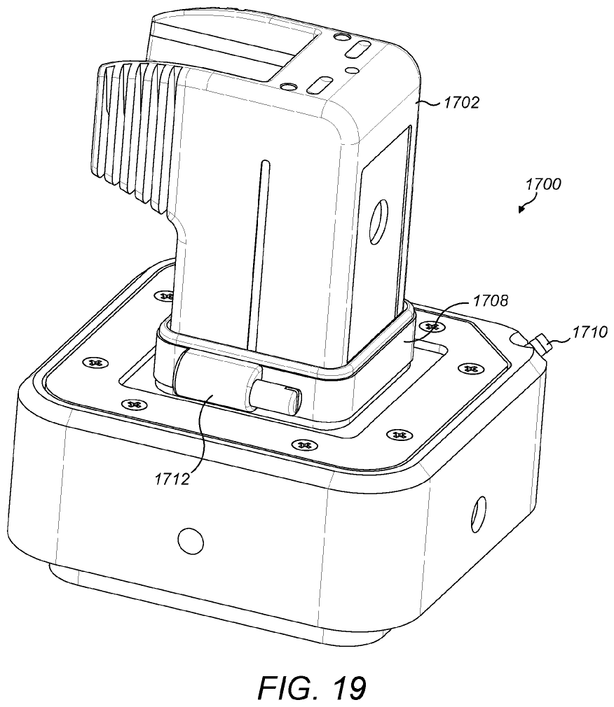

FIG. 19 shows a further perspective view of a coupling shoe 1700 engaged with a transducer module 1702. The transducer engaging portion 1708 comprises a securing mechanism 1712 by which the transducer engaging portion can be secured to the transducer module. In the illustrated example the securing mechanism comprises a hose clamp-type collar that can be tightened. Thus, the transducer engaging portion can be used to mount the transducer module in a desired position, and the securing mechanism can be tightened to restrict relative movement between the coupling shoe and the transducer module.

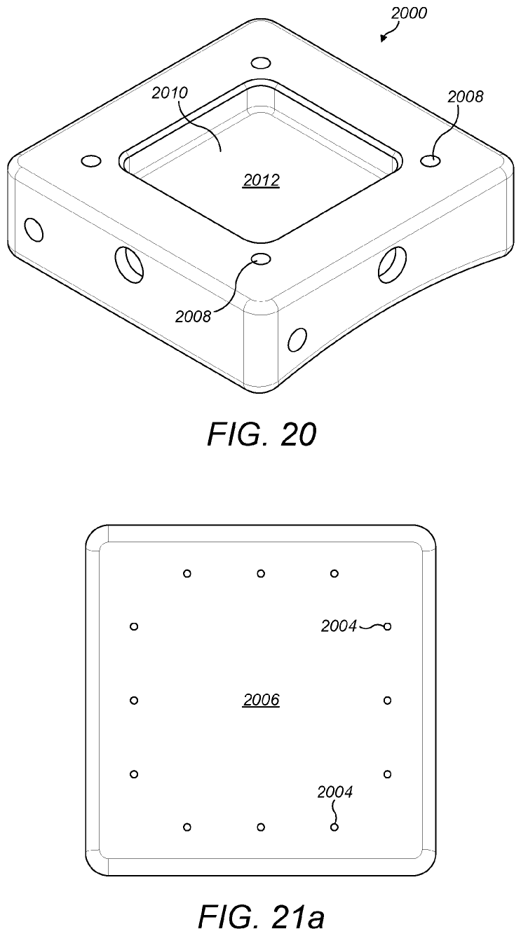

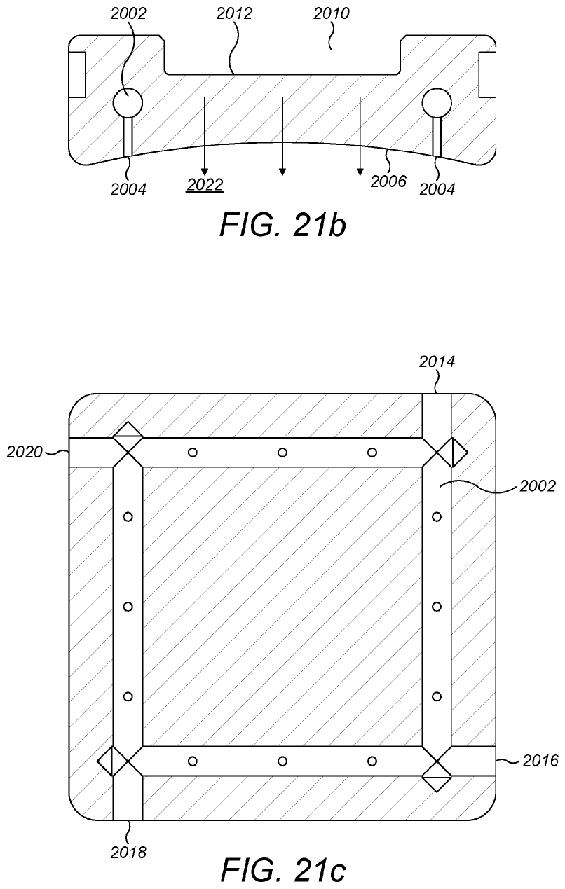

In another example, with reference to FIG. 20, the coupling shoe 2000 comprises a couplant chamber 2002 provided with at least one outlet 2004 for dispensing couplant to an interface with the target object. The or each outlet is provided on a probe surface 2006 of the coupling shoe. FIG. 21a shows the underside of the coupling shoe 2000. FIG. 21b shows a side cutaway view of the coupling shoe 2000. FIG. 21c shows a plan cutaway view of the coupling shoe 2000.

The coupling shoe comprises engaging mechanisms 2008 for engaging the coupling shoe with a transducer. In FIG. 20 the engaging mechanisms 2008 take the form of screw holes. The coupling shoe comprises a recess 2010 into which the transducer module is receivable. When engaged with the coupling shoe, an ultrasound-emitting surface of the transducer module abuts against a transducer-coupling surface of the coupling shoe 2012. Suitably the transducer-coupling surface is planar. This allows continuous contact across the transducer-coupling surface with the ultrasound-emitting surface of the transducer module.

The couplant chamber 2002 in the illustrated example takes the form of a channel bored through the coupling shoe. The bore may be circular in cross-section, enabling the couplant chamber to be bored by a drill bit. This improves ease of manufacturing. The couplant chamber can be formed by boring into the coupling shoe a plurality of times. The coupling shoe illustrated in FIGS. 20 and 21a-21c has a generally square cross-section in plan view. In this example, four bores are formed in the coupling shoe, at entry points 2014, 2016, 2018, 2020. Each bore connects with adjacent bores, forming a continuous channel around the interior of the coupling shoe. The bore entry points may be sealed to form the couplant chamber 2002. Sealing the bore entry points can be achieved in any convenient manner, for example by screwing a sealing screw (optionally with a gasket or O-ring) into the bore entry point. One or more bore entry points can form an inlet port for providing couplant into the couplant chamber. One or more bore entry points can form an outlet port for removing couplant from the couplant chamber. Suitably, one bore entry point 2014 forms an inlet port and one bore entry point 2018 forms an outlet port. Suitably the bore entry point forming the inlet port is opposite, or furthest away from, the bore entry point forming the outlet port. This arrangement enables couplant to flow along generally equivalent paths through the couplant chamber between the inlet port and the outlet port. In the illustrated example, one path passes bore entry point 2016 and the other path passes bore entry point 2020. The inlet port can couple to a couplant source, for example via a tube, as described elsewhere herein. Generally, the inlet port and the outlet port of this example of the coupling shoe can be coupled to systems as described elsewhere herein in respect of other examples of the coupling shoe.

Outlets 2004 from the couplant chamber 2002, through which couplant can flow towards the target object, are provided in the probe surface 2006. The outlets can be provided by boring into the coupling shoe 2000 from the probe surface. For example, the bores can be drilled from the probe surface to a depth within the coupling shoe such that the outlet bores communicate with the couplant bores. This is illustrated in FIG. 21b.

The outlets 2004 are provided towards a periphery of the probe surface 2006 of the coupling shoe 2000. The coupling shoe is configured to couple ultrasound transmitted by the transducer module into the target object along a transmission path through the coupling shoe, and the outlets are provided away from the material of the coupling shoe forming the transmission path. The provision of the outlets in this way can thereby avoid causing undesirable ultrasound reflections along the transmission path. Suitably, the transmission path is directly through the coupling shoe, for example perpendicular to a plane in which the transducer module is held by the coupling shoe. In the illustrated example, the ultrasound-emitting surface of the transducer module will engage with the planar transducer coupling surface of the coupling shoe 2012. The transmission path will, in this example, be generally perpendicular to this plane (as indicated schematically by arrows 2022).

The outlets 2004 are provided symmetrically about the coupling shoe, though they need not be in all examples. Providing the outlets symmetrically helps distribute the couplant between the coupling shoe and the target object. This can be beneficial where the coupling shoe moves relative to the target object in different directions across the surface of the target object. The distribution of the outlets around the periphery of the coupling shoe means that at least one outlet will generally face the direction of movement, and so provide couplant to an area of the target object to be scanned. Generally, the coupling shoe may have a polygonal outer shape, and a respective outlet may be provided in respect of each face of the polygon. A plurality of outlets may be provided in respect of one or more faces of the polygon. This arrangement assists in providing suitable couplant between the coupling shoe and the target object irrespective of the direction in which the coupling shoe is moved across the target object's surface.

In the illustrated example, the outlets are all of the same size aperture. This need not be the case. The outlets can be of differing sizes. For example, outlets at the corners of the coupling shoe can be smaller than outlets at the mid-points of faces of the coupling shoe, or vice-versa. The outlets can be between 1 mm and 5 mm in diameter. Suitably the outlets are between 1 mm and 3 mm in diameter. Providing outlets of this size obtains a good balance between large enough apertures to reduce bubble formation, but small enough apertures that too much couplant is not wasted. Such sized outlets also avoid the need for more outlets, because in the present example a sufficient amount of couplant can be dispensed through a relatively smaller number of relatively larger outlets. The use of a relatively smaller number of outlets can save time during manufacturing.

The couplant chamber 2002 is provided away from the transmission path. This arrangement avoids the ultrasound transmission path passing through the couplant within the coupling shoe itself, which might otherwise lead to additional reflections along the transmission path of the ultrasound (e.g. as the ultrasound would enter the couplant chamber).

In another example, a coupling shoe comprises a couplant chamber arranged to hold couplant for coupling ultrasound transmitted by the transducer module into the target object. The couplant chamber has an outlet for dispensing couplant to an interface with the target object. The coupling shoe is configured to reduce bubble formation in couplant flowing through the coupling shoe, and comprises a flow-regulating feature configured to decrease turbulent flow in couplant flowing through the coupling shoe. Suitably the flow-regulating feature comprises a bubble suppression feature.

The flow-regulating feature can comprise one or more chamfered portions. Providing chamfered portions reduces the angles of each individual corner. For example, providing a 45 degree chamfer on a 90 degree corner will replace the single 90 degree corner with two 45 degree corners. Thus, the provision of chamfers can reduce the angle of at least one corner past which couplant is configured to flow. The flow-regulating feature may comprise one or more smoothly curved portions, thereby reducing the number of corners and/or the angle of a corner, past which couplant is configured to flow. The flow-regulating feature may comprise an aperture with rounded edges. These approaches can reduce turbulent flow in couplant, such as eddies in the couplant. The flow-regulating feature may comprise a flow rate modulator to reduce the speed of flow of couplant, thereby reducing turbulent flow. The flow rate modulator may comprise an aperture and/or a passage with an increasing width along a flow direction through the aperture or passage. The flow-regulating feature may comprise a smooth surface. Such a smooth surface can reduce a number of bubble nucleation sites on the surface compared to a rougher surface.

Reducing turbulent flow can lead to a reduction in bubble formation in the couplant. This can, in turn, reduce bubbles in the couplant coupling the ultrasound into and out of the target object, improving the resulting ultrasound scan.

Any one or more of the coupling shoes described herein can be formed, at least in part, from a transparent material. For example, the transparent material can comprise an acrylic material such as clear acryl. The coupling shoe suitably comprises transparent material between (i) a flow path of couplant within the coupling shoe and (ii) an exterior surface of the coupling shoe. This enables a user to view couplant within the coupling shoe during use and to thereby identify the presence and number of bubbles in the couplant. Identifying the presence and number of bubbles enables action to be taken if necessary, such as modifying the flow rate of couplant through the coupling shoe to reduce bubble formation or to clear bubbles out from the coupling shoe. Suitably the coupling shoe comprises transparent material between the couplant chamber and the exterior surface. The coupling shoe is preferably made entirely from the transparent material.

The apparatus and methods described herein are particularly suitable for detecting debonding and delamination in composite materials such as carbon-fibre-reinforced polymer (CFRP). This is important for aircraft maintenance. It can also be used detect flaking around rivet holes, which can act as a stress concentrator. The apparatus is particularly useful for detecting corrosion, welding, cracks, and so on, in metals or metallic structures. The apparatus is particularly suitable for applications where it is desired to image a small area of a much larger component. The apparatus is lightweight, portable and easy to use. It can readily be carried by hand by an operator to be placed where required on the object.

The structures shown in the figures herein are intended to correspond to a number of functional blocks in an apparatus. This is for illustrative purposes only. The functional blocks illustrated in the figures represent the different functions that the apparatus is configured to perform; they are not intended to define a strict division between physical components in the apparatus. The performance of some functions may be split across a number of different physical components. One particular component may perform a number of different functions. The figures are not intended to define a strict division between different parts of hardware on a chip or between different programs, procedures or functions in software. The functions may be performed in hardware or software or a combination of the two. Any such software is preferably stored on a non-transient computer readable medium, such as a memory (RAM, cache, FLASH, ROM, hard disk etc.) or other storage means (USB stick, FLASH, ROM, CD, disk etc). The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device. Any of the functional units described herein might be implemented as part of the cloud.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A coupling shoe for attachment to a transducer module to couple ultrasound transmitted by the transducer module into a target object, the coupling shoe comprising:
a transducer engaging portion;
a couplant chamber arranged to hold couplant; and
a flexible membrane at least partially defining a probe surface for facing the target object through which couplant from the couplant chamber can seep for coupling ultrasound transmitted by the transducer module into the target object.

2. A coupling shoe according to claim 1, in which:
the membrane defines substantially the whole of the probe surface, and/or
the membrane defines at least a portion of the couplant chamber, and/or
the membrane is porous and/or comprises a plurality of holes.

3-4. (canceled)

5. A coupling shoe according to claim 2, in which, where the membrane comprises the plurality of holes, the plurality of holes are arranged over substantially the whole of the membrane.

6. A coupling shoe according to claim 2, in which the dimensions of the holes are in the range of 50 μm maximum width to 1000 μm maximum width.

7. A coupling shoe according to claim 2, in which the density of holes in the membrane is in the range of 1 hole per square mm to 1 hole per square cm.

8. A coupling shoe according to claim 1, in which the membrane is disposed away from an ultrasound transmission path.

9. A coupling shoe according to claim 1, in which the couplant chamber is in communication with a couplant source.

10. A coupling shoe according to claim 1, in which the coupling shoe comprises
an inlet port in communication with the couplant chamber for supplying couplant to the chamber, and
an outlet port in communication with the couplant chamber through which couplant can flow out of the couplant chamber.

11. (canceled)

12. A coupling shoe according to claim 1, in which the coupling shoe comprises a contact-sensitive actuator for controlling couplant delivery to the couplant chamber.

13. A coupling shoe according to claim 12, in which the coupling shoe comprises an inlet port in communication with the couplant chamber for supplying couplant to the chamber, and in which the inlet port comprises the contact-sensitive actuator.

14. A coupling shoe according to claim 12, in which the contact-sensitive actuator is configured to control delivery of couplant in response to detecting a force that exceeds a threshold contact force.

15. A coupling shoe according to claim 1, in which a portion of the coupling shoe peripheral to the membrane comprises a resilient portion.

16. A coupling shoe according to claim 1, in which the transducer engaging portion comprises a transducer coupling surface for abutment to an ultrasound-emitting surface of the transducer module to couple ultrasound into the coupling shoe.

17. A coupling shoe according to claim 1, in which the transducer engaging portion is configured to mount the coupling shoe to the transducer module in a plurality of positions and/or at a plurality of orientations.

18. (canceled)

19. A coupling shoe according to claim 1, in which the transducer engaging portion comprises a friction fit mechanism.

20. A coupling shoe for attachment to a transducer module to couple ultrasound transmitted by the transducer module into a target object, the coupling shoe comprising:
a transducer engaging portion;
a couplant chamber arranged to hold couplant for coupling ultrasound transmitted by the transducer module into the target object, the couplant chamber having an outlet for dispensing couplant to an interface with the target object; and
an inlet in communication with the couplant chamber for supplying couplant to the couplant chamber, the inlet comprising a contact-sensitive actuator for controlling couplant delivery to the couplant chamber.

21-23. (canceled)

24. A scanning apparatus comprising a coupling shoe according to claim 1 and a transducer module.

25. A scanning apparatus according to claim 24, comprising a couplant source.

26. A scanning apparatus according to claim 24, comprising a controller configured to control one or more of:
the pressure of couplant in the couplant chamber, and
flow rate of couplant into and/or out of the couplant chamber, in dependence on one or more of ambient pressure, a velocity of the coupling shoe relative to the target object, temperature of couplant in the couplant chamber, ambient temperature, and an amplitude of a peak in an ultrasound scan.
